(19) United States
(12) Patent Application Publication
(10) Pub. No.: US 2010/0071139 A1
(43) Pub. Date: Mar. 25, 2010

(54) Screwdriver with hammer element in handle

(76) Inventor: James Milton Gallien, Hidden Hills, CA (US)

Correspondence Address: Jim Gallien, 24164 Lupin Hill Road, Hidden Hills, CA, 91302, US

(21) Appl. No.: 12/584,570

(22) Filed: Sep. 8, 2009

Related U.S. Application Data
(60) Provisional application No. 61/191,630, filed on Sep. 10, 2008.

(51) Int. Cl. B25B 15/00; B25B 23/16

(52) U.S. Cl. 7/165

(57) ABSTRACT

A screwdriver includes a handle which defines a longitudinal axis and a shank mounted to the handle. The shank extends axially along said longitudinal axis and defines an engagement end opposite said handle. An impact element is mounted to the handle. The impact element defines a hitting surface wherein the hitting surface extends at least ½″ from the handle.

This application is based on and claims the benefit of priority from Provisional Patent application Ser. No. 61/191,630, filed Sep. 10, 2008, the entire contents of which are incorporated herein by reference.

### BACKGROUND OF THE INVENTION

a) Field of the Invention

The present invention relates to a screwdriver, and more particularly to a screwdriver equipped with an integral hammer-like hitting surface surface.

b) Description of the Prior Art

Conventional screwdrivers generally include a metal shank secured to a handle at one end and shaped to form an engagement end. As is well known, the engagement end is sized and shaped to fit particular size mating fastener, such as a Phillips head screw, a slotted-type screw, a Tome head, a square-drive head, a hex-drive head, or other.

The handle can be made from wood, metal or plastic, but today's screwdrivers generally include plastic handles that are molded about the shaft during their manufacture, or provided with a bore into which the shaft is press-fit.

History has shown that it is often beneficial to combine a screwdriver and a hammer together as a single tool and it is well known to provide a conventional screwdriver with an integral hammering surface. The resulting combined tool allows a user to quickly tap in a fastener to start it into a work surface and then use the screwdriver portion to continue to drive in the fastener. Carrying a heavy hammer is cumbersome for many simple jobs done around the house. Screwdrivers with some functionality to operate as a hammer are known. Some of these prior art screwdriver/hammer combination tools include an impact rod and spring configuration to exert a load to seat a fastener. Unfortunately, these types of combination tools are relatively complicated and expensive. Another common type of prior art screwdriver includes a metal shank that extends through the handle to provide a contact surface at an opposing end of the handle. This contact surface is intended to be struck with a hammer so that an impact force can be effectively transmitted through the shank to the engagement end and thereby used as necessary at a work surface. These prior art screwdrivers are relatively difficult to manufacture because they require that the contact surface be formed integrally with the shank.

Accordingly, it is desirable to provide a screwdriver with a hammer surface which is simple in construction, easy to manufacture and functional.

### SUMMARY OF THE INVENTION

The screwdriver of the present invention provides a hammer surface for tapping objects into place in addition to providing the functionality of a conventional screwdriver.

The present invention includes a handle, a shank and an impact element. The striking member is partially embedded into the rear end of the handle of the screwdriver. A hitting surface of the striking member is exposed on at least one side of the impact element. The impact element can be permanently secured to the handle or selectively removable from the handle. A further embodiment includes an impact element that in itself includes a hard main part and a softer attached part, attached thereto.

### BRIEF DESCRIPTION OF THE DRAWING FIGURES

The various features and advantages of this invention will become apparent to those skilled in the art from the following detailed description of the currently preferred embodiment. The drawings that accompany the detailed description can be briefly described as follows:

FIG. 1 is a general perspective assembly view of a screwdriver in accordance with a first embodiment of the present invention, showing details of an impact element apart from a handle of the screwdriver;

FIG. 2 is a general perspective view of the screwdriver of FIG. 1, in accordance with the first embodiment of the present invention, showing the impact element secured to the handle of the screwdriver;

FIG. 3 is a perspective view of an impact element, showing details of a projection, according to a second embodiment of the invention;

FIG. 4 is a perspective assembly view of a screwdriver according to a third embodiment of the invention, showing details of a combination shank and impact element;

FIG. 5 is a general perspective assembly view of a screwdriver in accordance with a second embodiment of the present invention, showing details of an impact element having a “soft” component and a hard component, the impact element being shown apart from a handle of the screwdriver and the soft component being shown apart from the hard component;

FIG. 6 is a general perspective view of the screwdriver of FIG. 5, in accordance with the second embodiment of the present invention, showing details of an impact element having a “soft” component secured to the hard component, the impact element being shown apart from a handle of the screwdriver,

FIG. 7 is a photograph showing the present invention being used as a hammer wherein the impact element is tapping a metal component into a wooden frame; and

FIG. 8 is a photograph showing the present invention being used as a screwdriver wherein an engagement tip of the screwdriver is driving a screw into sheetrock.

### DETAILED DESCRIPTION OF THE PREFERRED EMBODIMENTS

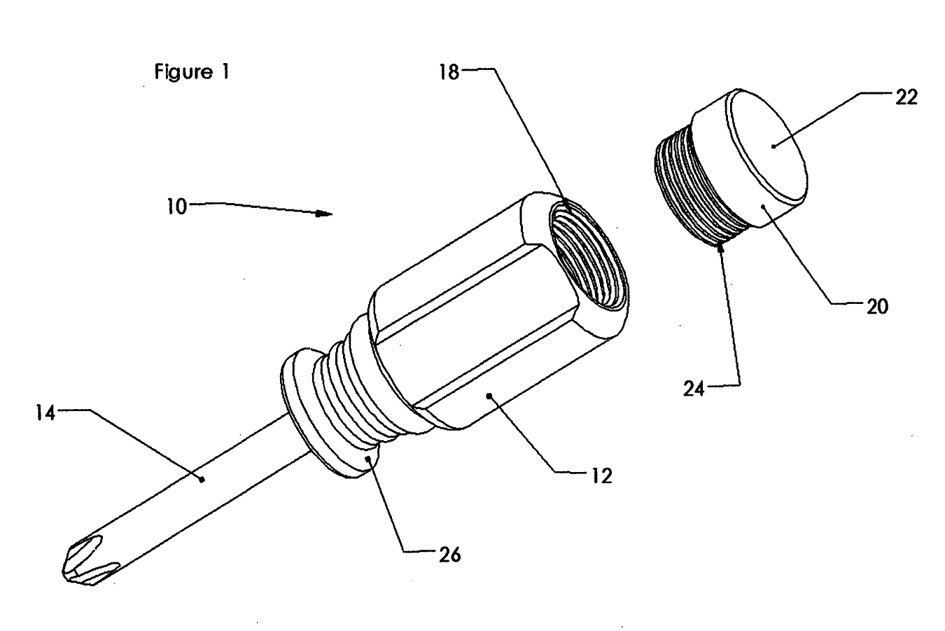

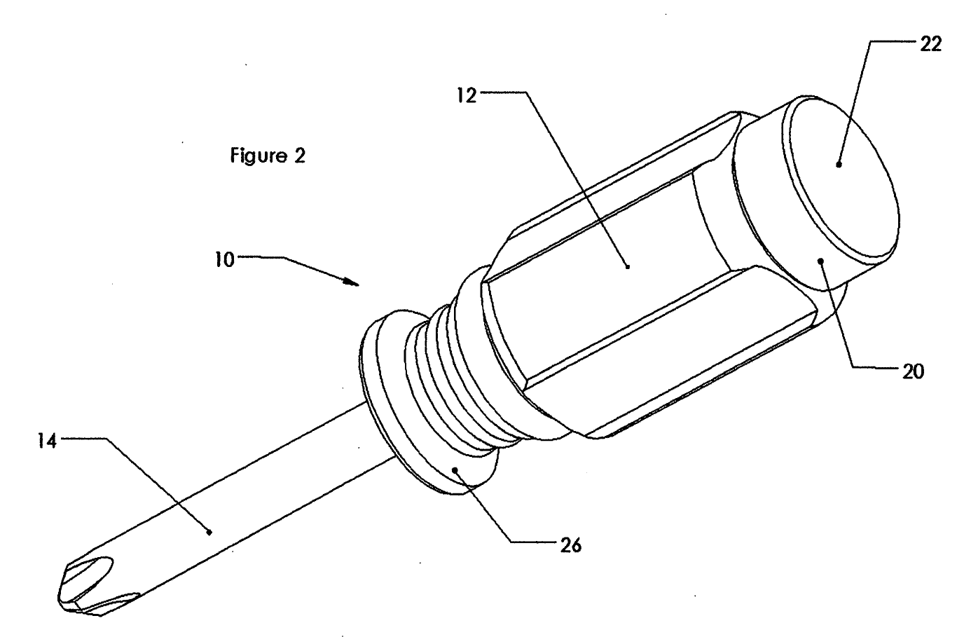

Referring to FIGS. 1 and 2, a screwdriver assembly 10 is shown, according to a first embodiment of the invention, including a handle 12, and a shank 14. Shank 14 is preferably made from a hardened steel, but may be made from any appropriate material depending on the intended application. Shank 14 is also preferably treated to prevent corrosion. Such treatments can include chrome plating, nickel plating, or galvanizing, or painting, or coating with a rubber material. Regardless, shank 14 includes a forward fastener-engagement tip 15 and a rearward anchoring end (hidden from view in the figures). As is well known, anchoring end of shank 14 is secured into handle 12, as explained below.

The fastener-engagement tip 15 is sized and shaped to fit particular size mating fastener, such as a Phillips head screw, a slotted-type screw, a Torx® head, a square-drive head, a hex-drive head, or other. The engagement structure of the tip is usually formed by a grinding process, but any appropriate process may be employed. Tip 15 may alternately include well known structure for selectively receiving and holding a separate driver head bit (not shown) which in turn includes the appropriate engagement structure.

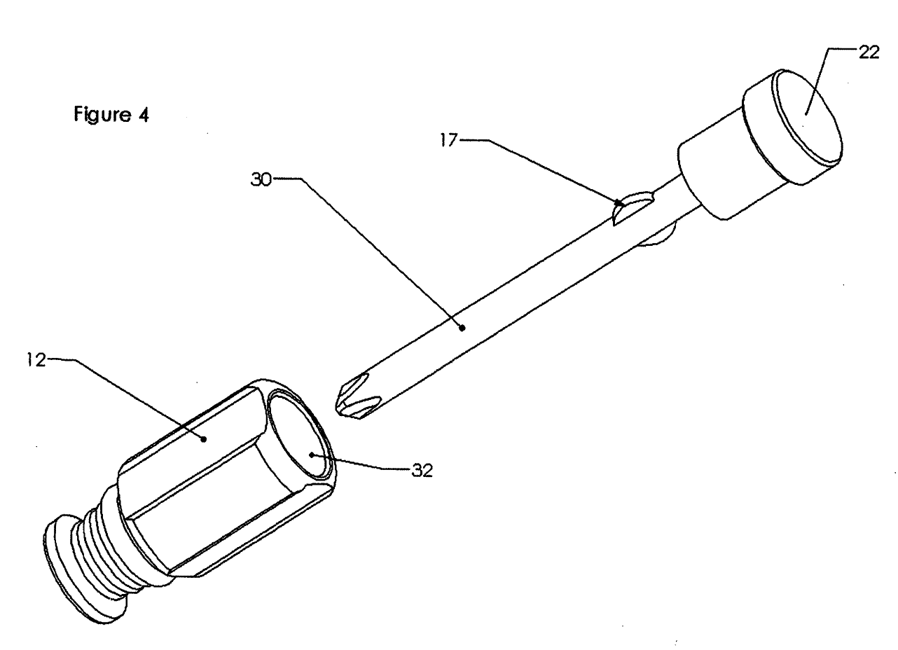

Although handle 12 may be made from wood, plastic, metal or even a high-durometer rubber, a tough appropriate plastic is preferred, such as PVC, or cellulose acetate. As is well known in the art, if the handle is made from plastic or rubber, it can be molded around shank 14 using an appropriate overlay molding technique. The anchoring end of shank 14 typically includes a roughened surface and/or a projection 17 (see FIG. 4) so that the shank will bond well with handle 12 as it molds itself therearound.

Alternatively, as is also well known in the art, handle 12 may be molded separately and thereafter provided with a bore into which the anchoring end of shank 14 may be pressed into locking frictional engagement.

As shown in FIGS. 1 and 2, handle 12 further includes a forward flange 26 sized and shaped to provide a finger purchase to the user during use of the tool. Handle 12 may include various other shapes and recesses to provide grip or ergonomic support for the user during the tool's use. Such shapes and recesses would be formed into handle 12 during the molding process. Handle 12 further includes a threaded bore 18 located at the rearward end (opposite the shank 14). Threaded bore 18 is sized and shaped to receive an impact element 20, described below. Threaded bore 18 may be formed integrally during the molding of handle 12 or formed during secondary drilling and tapping operations performed after handle 12 has already been molded.

As introduced above and according to the first embodiment of the invention, impact element 20 is attached to a rear end of handle 12. Impact element 20 may be made from a metal, such as bronze, brass, or steel, or even hard rubber or plastic, depending on the particular application intended. However, Applicant intends to use impact element 20 as a hammering surface for tapping in small nails, brads and other metal components into wood or sheetrock. Therefore, to aid in this task, impact element 20 is preferably made from a hardened steel and is preferably as dense as possible (i.e., high-density steel and also high in volume). The heavier the impact element 20 is (and the heavier the combined weight of the shank and the handle), the more effective the tool will be functioning as a hammer.

As shown in FIG. 2, impact element 20 includes a hitting surface 22 and a threaded portion 24. Threads 24 are sized and shaped to mate with the threads of threaded bore 18 of handle 12, described above. Impact element 20 can be made using any conventional techniques, such as drop-forged to a basic shape and thereafter ground and milled to final shape and finally tapped to form threads 24 and heat treated, as necessary to properly harden the steel. Alternatively, impact element 20 can be made by cutting rod stock to length, ground and milled, and tapped and heat treated. Other techniques can be employed as well, as would be understood by those skilled in the art.

After handle 12 and impact element 20 are made, the two parts are combined merely by mating threads 24 of impact element 20 with the threads of threaded bore 18 of handle 12 and tightened. As shown in FIG. 2, when impact element 20 is fully tight within threaded bore 18 of handle 12, threads 24 of impact element 20 are such that a portion (preferably about ½″) of impact element 20 remains projected beyond the rearmost end of handle 12. This projected portion of impact element 20 is now accessible and can be conveniently used as a hammer to effectively tap in small nails, brads and other metal components into wood and sheetrock.

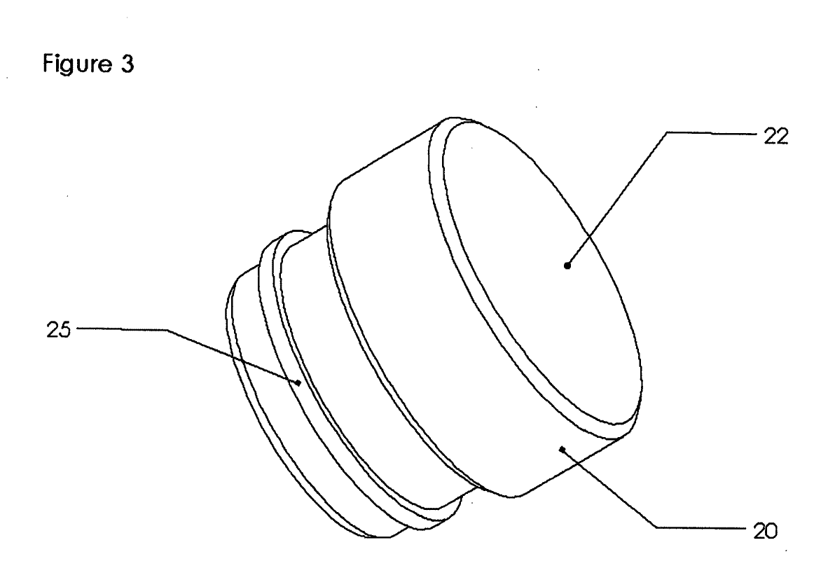

Referring to FIG. 3, a second embodiment of the invention is shown. Although handle 12 and impact element 20 is shown and described above as being secured to handle 12 using threads 24 and threaded bore 18, impact element can alternatively be provided with at least one gripping projection 25 in place of threads 24 so that impact element can be molded directly into the rear end of handle 12 during the molding of handle 12. Handle 12 is not shown in FIG. 3, but it is understood that conventional molding techniques can be used to form plastic handle 12 around impact element 20 in such a manner that allows the molten plastic can formed around and anchor to projection 25, thereby holding impact element in place. It is noted that as in the first embodiment shown in FIGS. 1 and 2, and described above, impact element 20 is molded in place within handle 12 so that at least ½″ of impact element 20 extends beyond the rear end of handle 12 and can be used as a hammer.

Referring now to FIG. 4, a third embodiment of the invention is shown wherein impact element 20 is molded or formed integrally with shank 14 to form a combination shank 30. The combination shank 30 can be formed by using known techniques such as drop-forging, or milling, turning, and grinding to create the different features required. Thereafter, combination shank 30 can be either molded within handle 12 during the molding process of handle 12, as described above, or pressed into a bore formed within an already molded handle 12, as is known by those in the art. The press-fit process can also be useful to secure non-moldable handles to the combination shanks 30.

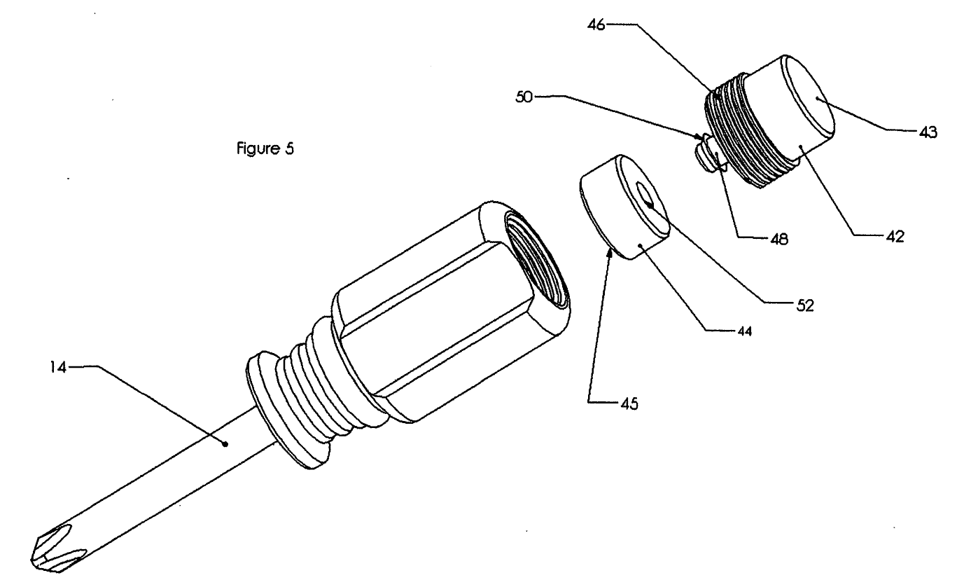

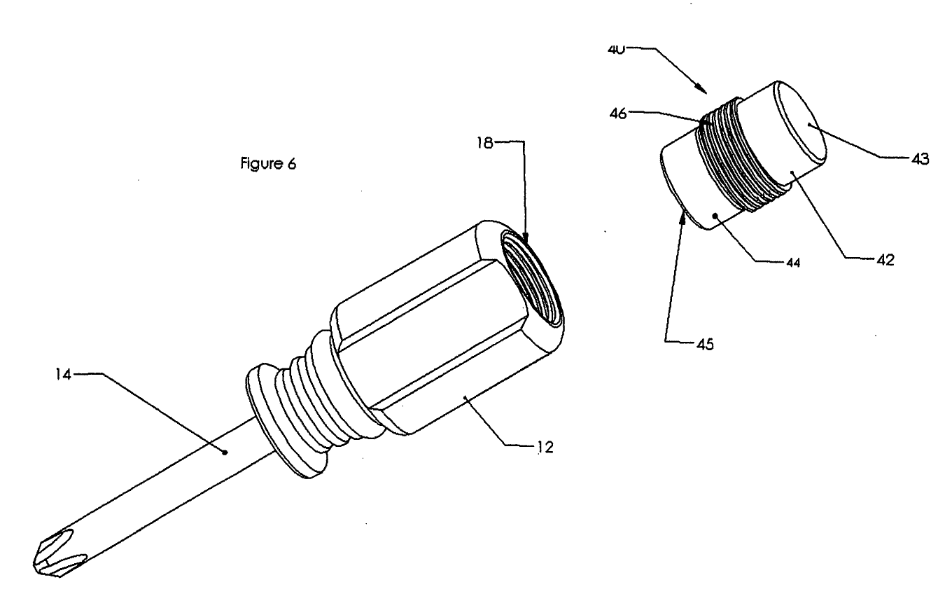

Referring now to FIGS. 5 and 6, a forth embodiment of the invention is shown wherein a impact element 40 is shown including two parts of different materials, a main part 42 which is preferably made from metal, such as bronze, brass, or steel and includes a hard impact surface 43, and an attached part 44 which is made from a softer material, such as plastic, high-durometer rubber (hard rubber), or leather and includes a soft impact surface 45. As shown in FIGS. 5 and 6, main part 42 includes a threaded portion 46, and as in the first embodiment of this invention, threaded portion 46 is sized to selectively mate with the threads of threaded bore 18 of handle 12. Main part 42 further includes an integrally formed projection 48 which includes a snap-and-lock element 50. According to this embodiment, attached part 44 includes a bore 52 which is sized and shaped to snap onto projection 48 and engage with element 50 in such a manner that secures attached part to main part 42, as shown in FIG. 6. Both main part 42 and attached part 44 are generally cylindrical in shape and include a diameter which is less than the diameter of threaded portion 46. This allows impact element 40 to be selectively secured to threaded bore 18 of handle 12 so that either hard impact surface 43 or soft impact surface 45 can be positioned outside handle 12. This allows the user to select an appropriate impact surface (soft or hard) depending on the desired application. A hard impact surface being useful for hitting small nails and brads into wood or sheetrock while a soft impact surface may be useful for tapping fragile materials into alignment, for example glass or finished wooden frames—materials that you don't want to become marred.

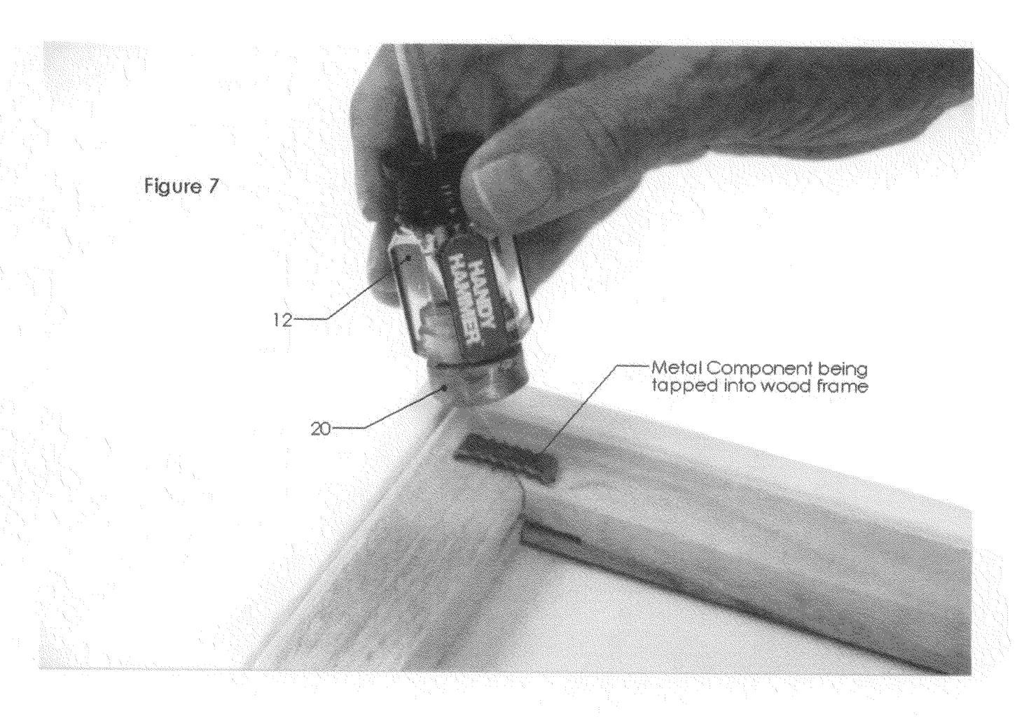

Referring now to FIG. 7, a photograph shows the hand of a user holding screwdriver assembly 10 in such a manner that faces impact element towards a work surface (which is a wooden frame). The user is moving the screwdriver assembly 10 in a striking motion like a hammer so that impact element impacts a metal component and the weight of the screwdriver assembly 10 transfers kinetic energy to driving the metal component into the wooden frame.

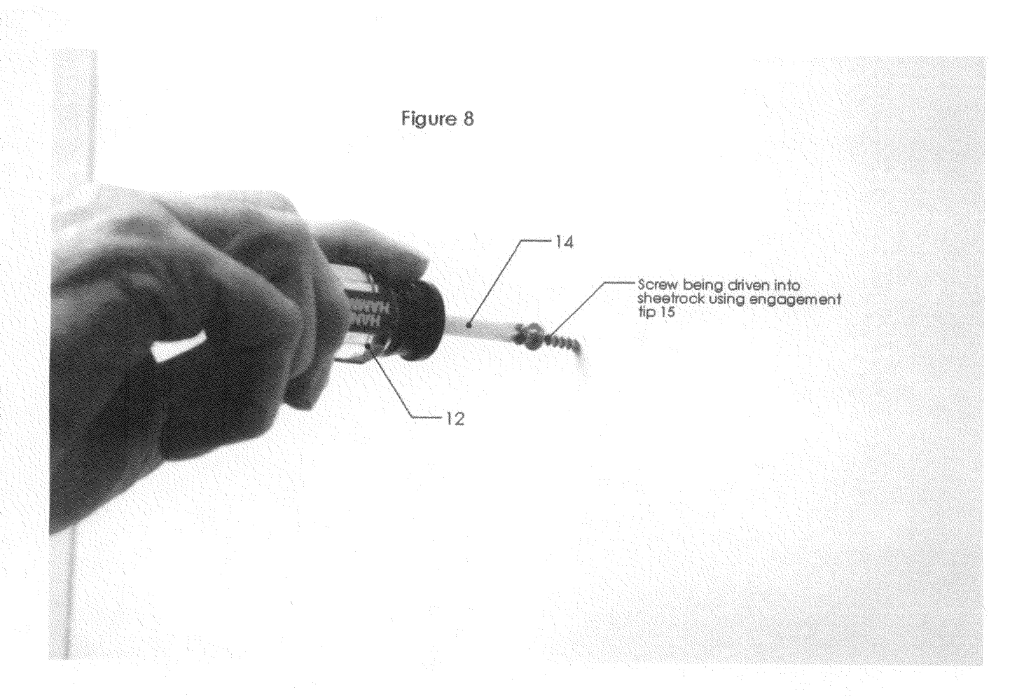

FIG. 8 also includes a photograph, but know the user is holding the screwdriver assembly 10 in such a manner that allows it to be used as a conventional screwdriver wherein engagement tip 15 engages the head of a screw (in this case, a Phillips drive), and the handle 12 can then be rotated in a conventional manner to impart torque from the user's muscles to rotate and drive the screw into the sheetrock wall.

That the foregoing description shall be interpreted as illustrative and not in a limiting sense is thus made apparent. A worker of ordinary skill in the art would recognize that certain modifications would come within the scope of this invention. For that reason, the following claims should be studied to determine the true scope and content of this invention.

What is claimed is:

1. A screwdriver, comprising:
a handle which defines a longitudinal axis;
a shank mounted to said handle, said shank extending axially along said longitudinal axis to define an engagement end opposite said handle; and
an impact element mounted to said handle, said impact element defining a hitting surface, said hitting surface extending from said handle at least ½″.

2. The screwdriver as recited in claim 1, wherein said impact element is partially embedded in said handle.

3. The screwdriver as recited in claim 1, wherein said impact element is made from hardened steel.

4. The screwdriver as recited in claim 1, wherein said impact element is made from bronze.

5. The screwdriver as recited in claim 1, wherein said hitting surface of said impact element is flat.

6. The screwdriver as recited in claim 1, wherein said handle includes a threaded bore and wherein said impact element is generally cylindrical and includes screw threads which are sized to selectively engage with the threads of said threaded bore.
